(19) United States
(12) Patent Application Publication
(10) Pub. No.: US 2020/0225521 A1
(43) Pub. Date: Jul. 16, 2020

(54) DISPLAY DEVICE

(71) Applicant: Samsung Display Co., Ltd., Yongin-si (KR)

(72) Inventors: Sang-Gil LEE, Seoul (KR); JINHO PARK, Suwon-si (KR); DONGIL SON, Seoul (KR); Namheon KIM, Seongnam-si (KR); TaeGyun KIM, Seoul (KR)

(21) Appl. No.: 16/729,669

(22) Filed: Dec. 30, 2019

(30) Foreign Application Priority Data
Jan. 14, 2019 (KR) 10-2019-0004604

(51) Int. Cl. G02F 1/13363; G02F 1/13357

(52) U.S. Cl. CPC G02F 1/13363; G02F 1/133606; G02F 2001/133614; G02F 2001/133638; G02F 1/133603

(57) ABSTRACT

A display device includes a light emitting unit which generates and emits a first color light; an optical member in which the first color light which is incident from the light emitting unit is color-converted and from which color-converted light is emitted; and a display panel to which the color-converted light which is emitted from the optical member is provided. The optical member includes: a quantum dot member which transmits a portion of the first color light and color-converts a portion of the first color light into a second color light and a third color light; and a filter member between the light emitting unit and the quantum dot member, the filter member including a cholesteric liquid crystal layer which reflects the second color light or the third color light which is incident to the filter member from the quantum dot member.

This application claims priority to Korean Patent Application No. 10-2019-0004604, filed on Jan. 14, 2019, and all the benefits accruing therefrom under 35 U.S.C. § 119, the entire content of which is herein incorporated by reference.

### BACKGROUND

### (1) Field

The present disclosure herein relates to a display device, and more particularly, to a display device with improved display quality.

(2) Description of the Related Art

A display device such as a liquid crystal display device generates an image using light provided from a backlight unit. The backlight unit includes a plurality of light emitting units which generate and emit light which is provided to a display panel within the liquid crystal display device. Each of the plurality of light emitting units includes a plurality of light emitting elements which generates and emits light.

An optical member within the display device is provided for improving characteristics of the light emitted from the light emitting units. The light from the light emitting units passes through the optical member before being provided to the display panel.

### SUMMARY

The present disclosure provides a display device having reduced color bleeding.

An embodiment of the invention provides a display device including: a light emitting unit which generates and emits a first color light; an optical member in which the first color light which is incident from the light emitting unit is color-converted and from which color-converted light is emitted; and a display panel to which the color-converted light which is emitted from the optical member is provided. The optical member includes: a quantum dot member which transmits a portion of the first color light and color-converts a portion of the first color light into a second color light and a third color light; and a filter member between the light emitting unit and the quantum dot member, the filter member including a cholesteric liquid crystal layer which reflects at least one of the second color light and the third color light which is incident to the filter member from the quantum dot member.

In an embodiment, the first color light may have a maximum peak wavelength of about 410 nanometers (nm) to about 480 nm.

In an embodiment, the optical member may include a base substrate which overlaps the light emitting unit, and the base substrate may include a glass substrate.

In an embodiment, the optical member may further include a base substrate which overlaps the light emitting unit, the base substrate including a lower surface facing the light emitting unit and an upper surface facing the display panel, and the cholesteric liquid crystal layer may form an interface with the lower surface or the upper surface of the base substrate.

In an embodiment, the cholesteric liquid crystal layer may form an interface with the quantum dot member.

In an embodiment, the filter member may further include: a base film; and an adhesive layer which bonds the base film to the cholesteric liquid crystal layer.

In an embodiment, the optical member may include a first cholesteric liquid crystal layer which reflects the second color light and a second cholesteric liquid crystal layer which reflects the third color light.

In an embodiment, the filter member may further include a base film disposed between the first cholesteric liquid crystal layer and the second cholesteric liquid crystal layer.

In an embodiment, the base film may be a λ/2 phase retardation film.

In an embodiment, the filter member may further include: a base film; a first adhesive layer which bonds the base film to the first cholesteric liquid crystal layer; and a second adhesive layer which bonds the first cholesteric liquid crystal layer to the second cholesteric liquid crystal layer.

In an embodiment, the second color light may have a maximum peak wavelength of about 515 nm to about 545 nm. Liquid crystal molecules, within the first cholesteric liquid crystal layer, may be arranged in a helix. An extraordinary refractive index (nₑ) of the liquid crystal molecules may be about 1.7 to about 1.9 and an ordinary refractive index (nₒ) of the liquid crystal molecules may be about 1.5 to about 1.7. A helical pitch of the first cholesteric liquid crystal layer may be about 320 nm to about 340 nm.

In an embodiment, the third color light may have a maximum peak wavelength of about 610 nm to about 645 nm. Liquid crystal molecules, within the second cholesteric liquid crystal layer of a same filter member comprising the first cholesteric liquid crystal layer, may be arranged in a helix. An extraordinary refractive index (nₑ) of the liquid crystal molecules may be about 1.7 to about 1.9 and an ordinary refractive index (nₒ) of the liquid crystal molecules may be about 1.5 to about 1.7. A helical pitch of the second cholesteric liquid crystal layer may be about 370 nm to about 390 nm.

In an embodiment, the light emitting unit may include a circuit substrate and a plurality of light emitting elements which are mounted on the circuit substrate.

In an embodiment, the plurality of light emitting elements may be independently turned on and turned off.

In an embodiment, the optical member may further include a scattering layer which scatters light incident thereto, the scattering layer disposed between the quantum dot member and the light emitting unit.

In an embodiment, the scattering layer may include a base resin layer and scattering particles which are in the base resin layer, and the scattering particles may include at least one of TiO₂, SiO₂, ZnO, Al₂O₃, BaSO₄, CaCO₃, and ZrO₂.

In an embodiment of the invention, a display device includes: a light emitting unit which generates and emits a blue light; an optical member in which the blue light which is incident from the light emitting unit is color-converted and from which color-converted light is emitted; and a display panel to which the color-converted light which is emitted from the optical member is provided. The optical member includes: a quantum dot layer which transmits a portion of the blue light and color-converts a portion of the blue light into green light and red light; and a filter member between the light emitting unit and the quantum dot layer, the filter member including: an upper surface facing the quantum dot layer, and a cholesteric liquid crystal layer having a helical structure in which liquid crystal molecules are twisted along a helical axis and an extending direction of the helical axis is normal with respect to the upper surface of the filter member.

In an embodiment, the optical member may further include a glass substrate which overlaps the light emitting unit, the glass substrate including a lower surface facing the light emitting unit and an upper surface facing the display panel, and the cholesteric liquid crystal layer may form an interface with the lower surface or the upper surface of the glass substrate.

In an embodiment, the filter member may include a first cholesteric liquid crystal layer which reflects the green light and a second cholesteric liquid crystal layer which reflects the red light.

In an embodiment, the filter member may further include a λ/2 phase retardation film disposed between the first cholesteric liquid crystal layer and the second cholesteric liquid crystal layer.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1 is an exploded perspective view of an embodiment of a display device according to the invention;

FIG. 2A is a top plan view illustrating an embodiment of a portion of a display device according to the invention;

FIG. 2B is a top plan view of an embodiment of a portion of a light emitting unit according to the invention;

FIG. 3A is a cross-sectional view illustrating an embodiment of a portion of a display device according to the invention;

FIG. 3B is a cross-sectional view of an embodiment of a filter member in a display device according to the invention;

FIG. 4A is an enlarged cross-sectional view of an embodiment of a liquid crystal layer in a filter member according to the invention;

FIG. 4B is a graph showing a transmission spectrum of an embodiment of a filter member according to the invention;

FIG. 4C is an enlarged cross-sectional view of an embodiment of a filter member according to the invention;

FIGS. 5A and 5B are enlarged cross-sectional views of modified embodiments of a filter member according to the invention;

FIG. 5C is a graph showing a transmission spectrum of an embodiment of a filter member according to the invention;

FIGS. 6A and 6B are graphs showing color differences related to distances from a light emitting reference point of a light emitting element of a display device according to the invention; and

FIGS. 7A to 7D are cross-sectional views illustrating modified embodiments of a portion of a display device according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like numbers refer to like elements throughout. The thickness and the ratio and the dimension of the element are exaggerated for effective description of the technical contents.

It will be understood that when an element is referred to as being related to another element such as being “on” another element, it can be directly on the other element or intervening elements may be present therebetween. In contrast, when an element is referred to as being related to another element such as being “directly on” another element, there are no intervening elements present.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

As used herein, the singular forms, “a”, “an” and “the” are intended to include the plural forms as well, unless the context clearly indicates otherwise. As used herein, the term “and/or” includes any and all combinations of one or more of the associated listed items. “At least one” is not to be construed as limiting “a” or “an.” “Or” means “and/or.”

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

It will be further understood that the terms “includes” or “have”, when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings.

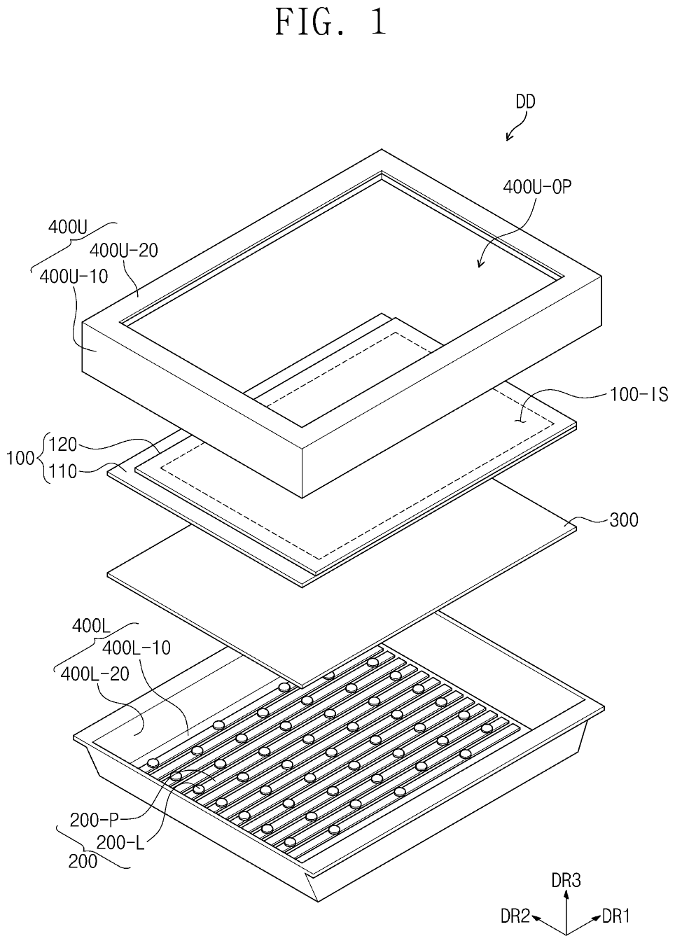

FIG. 1 is an exploded perspective view of an embodiment of a display device DD according to the invention. As illustrated in FIG. 1, a display device DD includes a display panel 100, a light emitting unit 200 provided in plural, an optical member 300, and protection members 400L and 400U. As applicable to an entirety of the present disclosure, the light emitting unit 200 provided in plural may be otherwise referred to as the light emitting elements 200.

The display panel 100 receives light from the light emitting units 200 and displays an image. The display panel 100 is not particularly limited and may include a transmissive display panel or a transflective display panel such as a liquid crystal display panel, an electrophoretic display panel and an electrowetting display panel.

The display panel 100 may display an image via a display surface 100-IS. The display surface 100-IS is parallel to a plane defined by a first direction axis DR1 and a second direction axis DR2. A normal direction of the display surface 100-IS, that is, a thickness direction of the display panel 100 is taken along a third direction axis DR3. A light emitting direction of the display device DD may be defined in the third direction axis DR3.

A front surface (or an upper or a top surface) and a back surface (or a lower or a bottom surface) of each member or unit described below are defined with reference to the third direction axis DR3. However, the first to third direction axes DR1, DR2 and DR3 illustrated in the embodiments are merely exemplary directions. Hereinafter, the first to third directions are defined as the directions indicated by the first to third direction axes DR1, DR2 and DR3, respectively, and refer to the same reference numerals.

Although the display panel 100 is exemplarily illustrated as being flat in this embodiment, the display panel 100 may have a display surface 100-IS which is curved in an embodiment of the invention. A shape of the display panel 100 is not particularly limited.

In this embodiment, the display panel 100 is described as a liquid crystal display panel (e.g., liquid crystal display panel 100). The liquid crystal display panel includes a first substrate 110, a second substrate 120 facing the first substrate 110, and a light control layer such as a liquid crystal layer (not illustrated) disposed between the first substrate 110 and the second substrate 120. A total planar area of the liquid crystal display panel may be divided into a display area, and a border area surrounding the display area. The display area is a planar area in which an image is displayed, and the border area is a planar area in which an image is not displayed while being disposed adjacent to the display area. A plurality of pixels are disposed in the display area. The plurality of pixels may be driven or controlling to transmit or block light for displaying an image. The display area may correspond to an inner area of the dotted line in FIG. 1. The border area may correspond to a planar area disposed outside of the dotted line in FIG. 1, without being limited thereto.

A pixel circuit including of a signal line and pixels is disposed on any one of the first substrate 110 and the second substrate 120 (hereinafter, an array substrate). The array substrate may be connected to a main circuit substrate separate from the array substrate, via a connection member such as a chip on film (“COF”).

A central control circuit for driving the display panel 100 is disposed on the main circuit substrate. The central control circuit may be a micro-processor. The chip of the COF may be a data driving circuit. A gate driving circuit may be mounted on the array substrate or may be integrated on the array substrate in a low temperature poly-silicone (“LTPS”) form. A driving or control signal may be provided from the main circuit substrate external to the display panel 100, and to the display panel 100, through the connection member.

The central control circuit may control operation of the light emitting units 200. A control signal for controlling on-off functions of the light emitting units 200 may be transmitted to a dimming circuit of the light emitting units 200.

The light emitting units 200 are disposed below the display panel 100 and the optical member 300. The light emitting units 200 generate a first color light. The first color light may include a light having a wavelength of about 410 nanometers (nm) to about 480 nm. The maximum peak wavelength of the first color light may be located in a range of about 440 nm to about 460 nm. The first color light may be a blue light.

Each of the light emitting units 200 includes a light emitting element 200-L provided in plural each including a point light source, and a circuit substrate 200-P providing an electric signal to the light emitting element 200-L. As applicable to an entirety of the present disclosure, the light emitting element 200-L and the circuit substrate 200-P provided in plural may be otherwise referred to as light emitting elements 200-L and circuit substrates 200-P, respectively. Each of the plurality of light emitting elements 200-L may include of a light emitting diode. Each of the light emitting units 200 may include a different number of light-emitting elements 200-L.

Although not illustrated separately, the display device DD may further include a circuit substrate for electrically connecting the light emitting units 200 to each other and/or other elements within the display device DD. The dimming circuit may be disposed on the circuit substrate. The dimming circuit dims the light emitting units 200 based on the control signal received from the central control circuit. The plurality of light emitting elements 200-L may be simultaneously turned on or off, or may be turned on or off independently.

The optical member 300 is disposed below the display panel 100 and above the light emitting units 200. The optical member 300 receives the first color light from the light emitting units 200. The optical member 300 partially transmits the first color light, and partially color-converts the first color light into a second color light and a third color light each different from the first color light.

The second color light may include a light having a wavelength of about 500 nm to about 570 nm. The third color light may include a light having a wavelength of about 580 nm to about 675 nm. The maximum peak wavelength of the second color light may be located in a range of about 515 nm to about 545 nm. The second color light may be a green light. The maximum peak wavelength of the third color light may be located in a range of about 610 nm to about 645 nm. The third color light may be a red light.

The protection members 400L and 400U include a first protection member 400L disposed below the light emitting units 200 and a second protection member 400U disposed above the display panel 100. The first protection member 400L and the second protection member 400U are coupled to each other to accommodate therebetween the display panel 100, the light emitting units 200 and the optical member 300. The first protection member 400L and the second protection member 400U may include or be made of a metal or a plastic. The protection members 400L and 400U may further include a mold member not illustrated. Components of the display device DD may be supported on the mold member within the display device DD, without being limited thereto.

The first protection member 400L accommodates the light emitting units 200 in a receiving space of the first protection member 400L. The first protection member 400L includes a bottom portion 400L-10 and a side wall portion 400L-20 which is bent and extended from edges of the bottom portion 400L-10. As applicable to an entirety of the present disclosure, the side wall portion 400L-20 may include individual side wall portions and be otherwise referred to as side wall portions 400L-20. The bottom portion 400L-10 may have a rectangular shape and the first protection member 400L may include four side wall portions 400L-20. The shape of the first protection member 400L is not particularly limited. The number of the side wall portions 400L-20 may be changed and/or a stepped portion may be disposed or formed on or by the bottom portion 400L-10 and/or the side wall portions 400L-20. The bottom portion 400L-10 and the side wall portions 400L-20 may together define the receiving space.

The light emitting units 200 are mounted on the bottom portion 400L-10. The light emitting units 200, specifically the circuit substrates 200-P may substantially completely cover a total planar area of the bottom portion 400L-10. A total planar area occupied by planar areas of the circuit substrates 200-P may cover more than 90% of a total planar area of the bottom portion 400L-10.

The second protection member 400U is disposed above the display panel 100 to cover the edge area of the display panel 100. The second protection member 400U is provided with an opening 400U-OP through which an image is passed and viewable from outside the display device DD. The opening 400U-OP corresponds to the display area of the display panel 100.

The second protection member 400U may have a rectangular frame shape on a plane. The second protection member 400U may be divided into four portions. The four portions may have an integral shape or may include separately-provided portions subsequently assembled to each other. Each of the four portions includes a side wall portion 400U-10 and a front portion 400U-20 which is bent from the side wall portion 400U-10. The front portions 400U-20 of the four portions substantially define the opening 400U-OP. In an embodiment of the invention, the front portion 400U-20 may be omitted. In an embodiment of the invention, the second protection member 400U may be omitted.

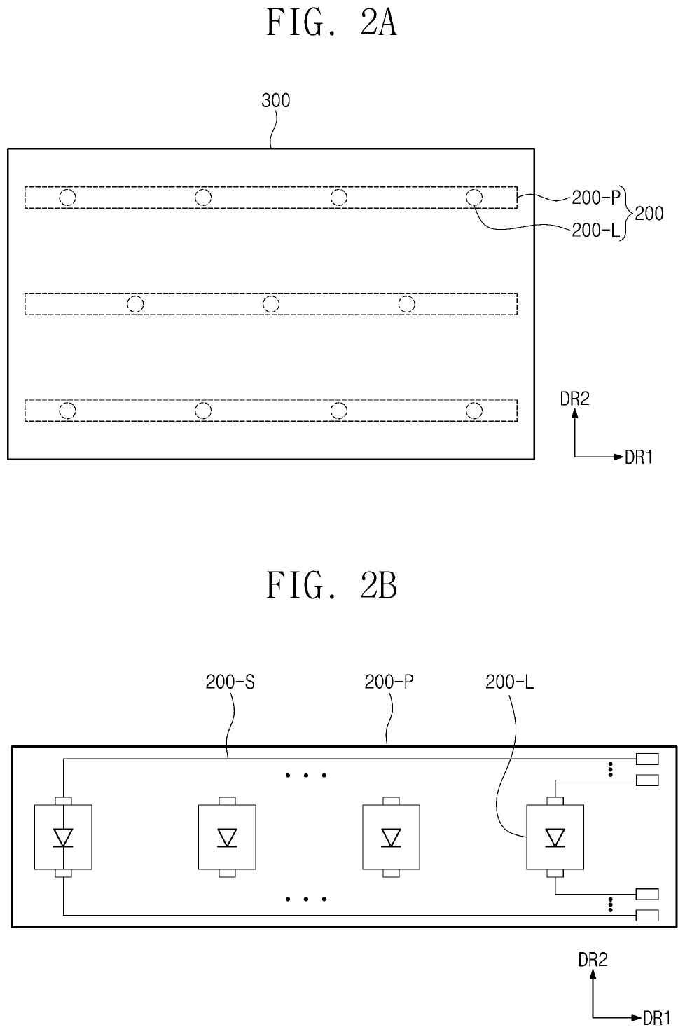

FIG. 2A is a top plan view illustrating an embodiment of a portion of a display device DD according to the invention. FIG. 2B is a top plan view of an embodiment of a portion of a light emitting unit 200 according to the invention.

As illustrated in FIGS. 2A and 2B, each of the light emitting units 200 includes light emitting elements 200-L and a circuit substrate 200-P. FIG. 2A illustrates some light emitting units 200 among the light emitting units 200 illustrated in FIG. 1, as dotted line elements since the light emitting unites 200 are under the optical member 300. As illustrated in FIG. 2B, the light emitting elements 200-L are connected to signal lines 200-S for dimming. Referring to FIG. 2B, each light emitting element 200-L is connected to respective signal lines 200-S extending along a length of the circuit substrate 200-P (e.g., the middle two light emitting elements 200-L would be connected in a similar manner to those on the left and right of the circuit substrate 200-P), without being limited thereto.

A control signal for controlling on-off functions of the light emitting units 200 may be transmitted through the signal lines 200-S, such as to a dimming circuit of the light emitting units 200. As illustrated in FIGS. 2A and 2B, the circuit substrates 200-P each have a shape lengthwise extended in the first direction axis DR1 and widthwise extended in the second direction axis DR2.

Although not illustrated separately, the circuit substrate 200-P includes at least one insulation layer and at least one circuit layer. The circuit layer may include a plurality of conductive patterns, and the conductive patterns may include or define the signal lines 200-S illustrated in FIG. 2B.

The light emitting elements 200-L may include a light emitting diode. The light emitting diode generates light in response to a driving voltage applied thereto, such as via a first electrode and a second electrode of the light emitting diode. The light emitting diode may have a structure in which an n-type semiconductor layer, an active layer and a p-type semiconductor layer are sequentially stacked.

The first electrode and the second electrode of the light emitting diode are connected to connection terminals of the uppermost circuit layer of the circuit substrate 200-P. The light emitting elements 200-L may further include an encapsulation member for protecting the light emitting diode from an environment outside of the light emitting elements 200-L.

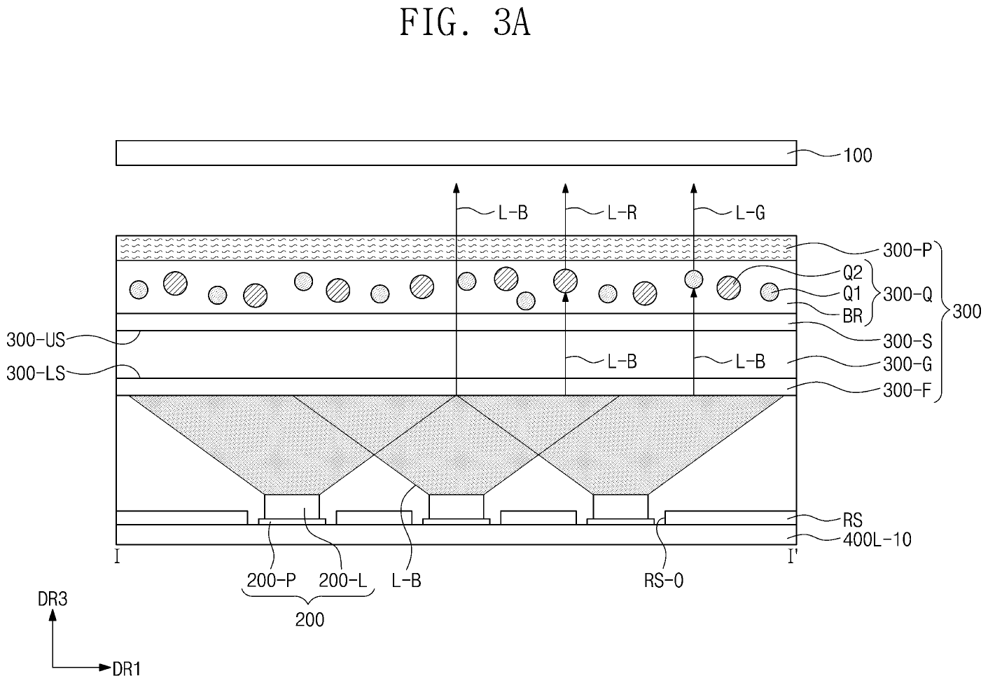

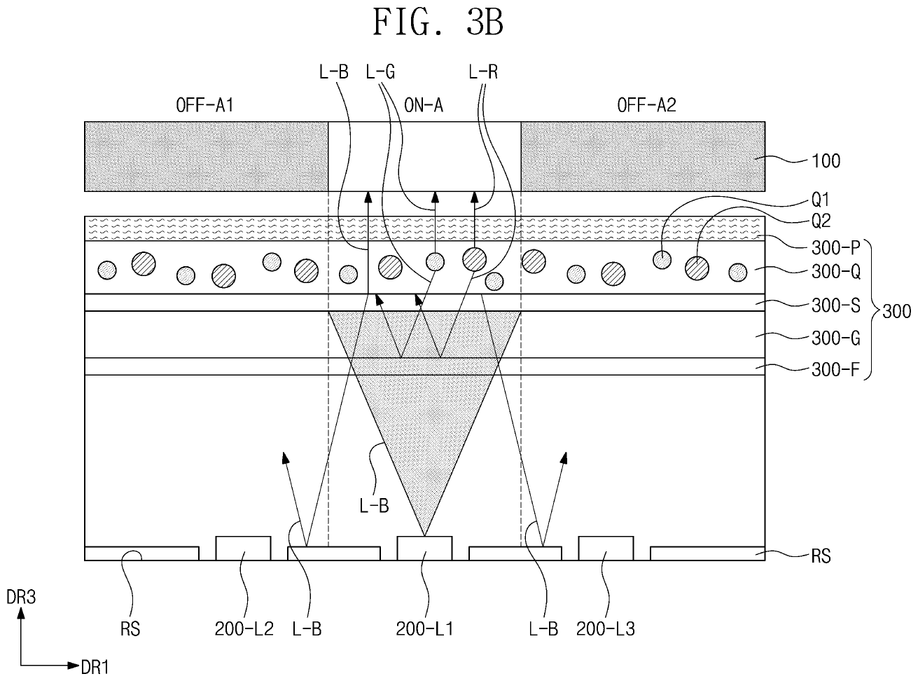

FIG. 3A is a cross-sectional view illustrating an embodiment of a portion of a display device DD according to the invention. FIG. 3B is a cross-sectional view of an embodiment of a filter member 300-F according to the invention.

As illustrated in FIG. 3A, an optical member 300 includes a base substrate 300-G, a scattering member 300-S, a quantum dot member 300-Q, a protection member 300-P, and a filter member 300-F. Hereinafter, each of the filter member 300-F, the quantum dot member 300-Q and the protection member 300-P may be a “film” type or a “layer” type. As applicable to an entirety of the present disclosure, a “film” or “layer” may have a relatively small thickness (e.g., along the third direction axis DR3) as compared to dimensions along a plane (e.g., defined by the first direction axis DR1 and the second direction axis DR2) in which the “film” or “layer” is disposed.

The film type member includes a base film. The base film may be a synthetic resin film and support functional layers of the film type member. The film type member may be bonded to another member different from the film type member, such as via an adhesive layer.

The layer type member does not include a base film. Functional layers of the layer type member may be disposed or formed on one side of another member different from the layer type member, such as through a continuous process.

As applicable to an entirety of the present disclosure, each of the filter member 300-F, the quantum dot member 300-Q and the protection member 300-P may be otherwise referred to as a “layer” which represents either the “film” type or the “layer” type described herein.

The base substrate 300-G supports thereon the filter member 300-F, the quantum dot member 300-Q, and the protection member 300-P. The base substrate 300-G overlaps the light emitting units 200 on a plane view (e.g., along the third direction axis DR3).

The base substrate 300-G may include a glass substrate, a synthetic resin substrate or a ceramic substrate. In an embodiment, the base substrate 300-G may be a glass substrate (e.g., glass substrate 300-G). Even if optical distances between the light emitting elements 200-L and the glass substrate 300-G are relatively small, defects minimally occur because the glass substrate 300-G is less susceptible to thermal deformation. The optical distance is defined as a shortest distance along the third direction axis DR3, between the light emitting elements 200-L and the glass substrate 300-G. In an embodiment, the optical distance between the light emitting elements 200-L and the glass substrate 300-G may be about 3 millimeters (mm) to about 8 mm. A thickness of the glass substrate 300-G may be about 0.3 millimeter (mm) to about 1 mm. Hereinafter, the base substrate 300-G is described as a glass substrate.

Although not illustrated separately, a scattering pattern may be formed on an upper surface 300-US and/or a lower surface 300-LS of the glass substrate 300-G. Concave patterns recessed from a common plane and in the thickness direction (e.g., the third direction axis DR3) may be defined on or by the lower surface 300-LS. Convex patterns protruding from a common plane and in the thickness direction may be defined on or by the upper surface 300-US.

The scattering member 300-S may be disposed on the upper surface 300-US of the glass substrate 300-G. In an embodiment, a layer type scattering member 300-S directly disposed on the upper surface 300-US of the glass substrate 300-G is exemplarily illustrated in FIG. 3A. In an embodiment of the invention, the scattering member 300-S may be omitted.

The scattering layer 300-S may reduce or effectively prevent a hot spot phenomenon by scattering first color light L-B which has passed through and been emitted from the upper surface 300-US of the glass substrate 300-G. The hot spot phenomenon is a phenomenon in which a light amount concentrates only in a portion of the display panel 100 overlapped with the light emitting element 200-L along the third direction axis DR3.

The scattering layer 300-S may include at least a base resin and scattering particles which are mixed (or dispersed) in the base resin. The base resin is a medium in which the scattering particles are dispersed and may include various resin materials generally referred to as a binder. However, the invention is not limited thereto, and any medium in which the scattering particles may be dispersed may be referred to as a base resin regardless of the name, additional other functions, or constituent materials, etc. The base resin may be a polymer resin. In an embodiment, for example, the base resin may be an acrylic-based resin, a urethane-based resin, a silicone-based resin, or an epoxy-based resin, etc. The base resin may be a transparent resin.

The scattering particles may have a refractive index of about 2 or more and may have a diameter of about 150 nm to about 400 nm. The scattering particles may include inorganic particles. The inorganic particles may be TiO₂, SiO₂, ZnO, Al₂O₃, BaSO₄, CaCO₃, or ZrO₂.

The quantum dot member 300-Q is disposed facing the upper surface 300-US of the glass substrate 300-G. The quantum dot member 300-Q may be a layer type or a film type. The quantum dot member 300-Q includes at least a quantum dot layer or a color conversion layer. FIG. 3A exemplary illustrates a quantum dot member 300-Q including only a quantum dot layer disposed on the scattering member 300-S.

The quantum dot layer may include a base resin BR and quantum dots Q1 and Q2 which are mixed (or dispersed) in the base resin BR. The base resin BR is a medium in which the quantum dots Q1 and Q2 are dispersed and may include various resin materials generally referred to as a binder. However, the invention is not limited thereto, and any medium in which the quantum dots Q1 and Q2 may be dispersed may be referred to as a base resin BR regardless of the name, additional other functions, or constituent materials, etc. The base resin BR may be a polymer resin. In an embodiment, for example, the base resin BR may be an acrylic-based resin, a urethane-based resin, a silicone-based resin, or an epoxy-based resin, etc. The base resin BR may be a transparent resin.

Although not illustrated separately, the quantum dot member 300-Q may further include barrier layers disposed to respectively contact the upper and lower surfaces of the base resin layer and form an interface therebetween. The barrier layers may be inorganic layers and seal the base resin layer from an environment outside of the quantum dot member 300-Q.

The quantum dots Q1 and Q2 may be particles which change a wavelength of light incident thereto, such as light provided from a light emitting unit 200 (FIG. 1). The quantum dots Q1 and Q2 have a crystal structure having a size of several nanometers, include hundreds to thousands of atoms, and exhibit a quantum confinement effect in which an energy band gap becomes larger due to the small sizes thereof. When light with a wavelength having a higher energy than the band gap energy is incident on the quantum dots Q1 and Q2, the quantum dots Q1 and Q2 absorb the light to become excited and fall to a ground state while emitting light with a specific wavelength. The light with the emitted wavelength has an energy corresponding to the band gap. The light from the quantum dots Q1 and Q2 which is emitted wavelength may have a different wavelength from the light incident to the quantum dots Q1 and Q2. Luminescence characteristics of the quantum dots Q1 and Q2 by the quantum confinement effect may be adjusted by adjusting the size and composition thereof.

The quantum dots Q1 and Q2 may be selected from among a Group II-VI compound, a Group III-V compound, a Group IV-VI compound, a Group IV element, a Group IV compound, and a combination thereof.

The Group II-VI compound may be selected from among a binary element compound selected from among CdSe, CdTe, ZnS, ZnSe, ZnTe, ZnO, HgS, HgSe, HgTe, MgSe, MgS, and a combination thereof, a ternary element compound selected from among CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and a combination thereof; and a quaternary element compound selected from among HgZnTeS, CdZnSeS, CdZnSeTe, CdZnSTe, CdHgSeS, CdHgSeTe, CdHgSTe, HgZnSeS, HgZnSeTe, HgZnSTe, and a combination thereof.

The Group III-V compound may be selected from among a binary element compound selected from among GaN, GaP, GaAs, GaSb, AlN, AlP, AlAs, AlSb, InN, InP, InAs, InSb, and a combination thereof; a ternary element compound selected from among GaNP, GaNAs, GaNSb, GaPAs, GaPSb, AlNP, AlNAs, AlNSb, AlPAs, AlPSb, InNP, InNAs, InNSb, InPAs, InPSb, GaAlNP, and a combination thereof; and a quaternary element compound selected from among GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, and a combination thereof.

The Group IV-VI compound may be selected from among a binary element compound selected from among SnS, SnSe, SnTe, PbS, PbSe, PbTe, and a combination thereof; a ternary element compound selected from among SnSeS, SnSeTe, SnSTe, PbSeS, PbSeTe, PbSTe, SnPbS, SnPbSe, SnPbTe, and a combination thereof and a quaternary element compound selected from among SnPbSSe, SnPbSeTe, SnPbSTe, and a combination thereof.

The Group IV element may be selected from among Si, Ge, and a combination thereof. The Group IV compound may be a binary element compound selected from among SiC, SiGe, and a combination thereof.

At this time, the binary element compound, the ternary element compound, or the quaternary element compound may be present in the particles having a relatively uniform concentration, or may be present in the particles having partially different concentration distributions.

The quantum dots Q1 and Q2 may be a core/shell structure including a core and a shell which surrounds the core. Alternatively, the quantum dots Q1 and Q2 may have another core/shell structure in which one quantum dot surrounds the other quantum dot. The interface between the core and the shell may have a concentration gradient in which the concentration of a chemical element present in the shell becomes lower toward the center of the particle.

The quantum dots Q1 and Q2 may be particles having a nanometer-scale size. The emission wavelength spectrum of the quantum dots Q1 and Q2 may have a full width of half maximum (“FWHM”) of about 45 nm or less. In an embodiment, the emission wavelength spectrum of the quantum dots Q1 and Q2 may have a full width of half maximum (“FWHM”) of about 40 nm or less, or more particularly about 30 nm or less, and thus color purity or color reproducibility of light emitted by the quantum dot member 300-Q may be improved in the above range. In addition, the light emitted via the quantum dots Q1 and Q2 is emitted in all directions, so that a viewing angle of the light may be improved.

Furthermore, a shape of the quantum dots Q1 and Q2 is not limited, and may include a nano-particle, a nano-tube, a nano-wire, a nano-fiber, or a nano-plate particle, etc. having a spherical shape, a pyramidal shape, a multi-arm shape, or a cubic shape.

In an embodiment, the quantum dot member 300-Q may include a plurality of quantum dots Q1 and Q2 which convert light incident thereto in a wavelength region into light of colors having different wavelength regions from that of the incident light. The plurality of quantum dots Q1 and Q2 may include a first quantum dot Q1 which converts the first color light L-B into a second color light L-G; and a second quantum dot Q2 which converts the first color light L-B into a third color light L-R.

Although not illustrated separately, the film type quantum dot member 300-Q may be attached on the upper surface 300-US of the glass substrate 300-G such as via an adhesive layer.

The protection member 300-P is disposed on the quantum dot member 300-Q, and receives light emitted from the quantum dot member 300-Q. In an embodiment, the protection member 300-P may be a layer type. The protection member 300-P may include an organic layer and/or an inorganic layer, and be directly disposed on the quantum dot member 300-Q. The protection member 300-P may be deposited or coated on the upper surface of the quantum dot member 300-Q in a method of manufacturing a display device DD. In an embodiment of the invention, the protection member 300-P may be omitted.

The filter member 300-F is disposed below the quantum dot member 300-Q and reflects at least one among the second color light L-G and the third color light L-R generated from the quantum dot member 300-Q and incident to the filter member 300-F. FIG. 3A exemplary illustrates a layer type filter member 300-F directly disposed on the lower surface 300-LS of the glass substrate 300-G.

According to the embodiment, the display device DD may further include a reflective sheet RS. The reflective sheet RS is commonly disposed corresponding to a plurality of light emitting units 200 and defines an opening RS-O provided in plural respectively corresponding to the light emitting elements 200-L. The reflective sheet RS may reflect the first color light L-B to increase light efficiency. The reflective sheet RS may have silver color, white color, or blue color.

FIG. 3B illustrates a first light emitting element 200-L1, a second light emitting element 200-L2, and a third light emitting element 200-L3 and a first display area ON-A, a second display area OFF-A1 and a third display area OFF-A2 corresponding thereto, respectively. The first to third display areas ON-A, OFF-A1, and OFF-A2 are partial areas of a display panel 100 (see FIG. 1).

The first display area ON-A displays an image using light generated from the first light emitting element 200-L which is turned on. That is, the first display area ON-A corresponds to the turned-on area of the light emitting unit 200. The second and third display areas OFF-A1 and OFF-A2 display no image or a black image since the second and third light emitting elements 200-L2 and 200-L3 are turned off. The second and third display areas OFF-A1 and OFF-A2 correspond to the turned-off area of the light emitting unit 200.

The first color light L-B generated from the first light emitting element 200-L is incident on a region of the quantum dot member 300-Q corresponding to the first display area ON-A. The corresponding region of the quantum dot member 300-Q generates the second color light L-G and the third color light L-R by transmitting a portion of the first color light L-B without color change, and color-converting another portion of the first color light L-B. Since the second color light L-G and the third color light L-R are emitted light (or Lambertian radiated light), a portion thereof may leak to the lower side of the quantum dot member 300-Q (e.g., downward arrows from first quantum dot Q1 and second quantum dot Q1, respectively). The filter member 300-F may reflect at least one among the second color light L-G and the third color light L-R which is leaked, back toward the quantum dot member 300-Q, to reduce an amount of the light which leaks into the second display area OFF-A1 and the third display area OFF-A2. The leakage light being incident on the second display area OFF-A1 and the third display area OFF-A2 is reduced or effectively prevented, to reduce a yellow hollow (or luminescence ring) phenomenon occurring in the periphery of the first display area ON-A. While light is illustrated as reflected at a surface of the filter member 300-F, light may be reflected at an inner area of the filter member 300-F, such as by a material, structure, etc. within the filter member 300.

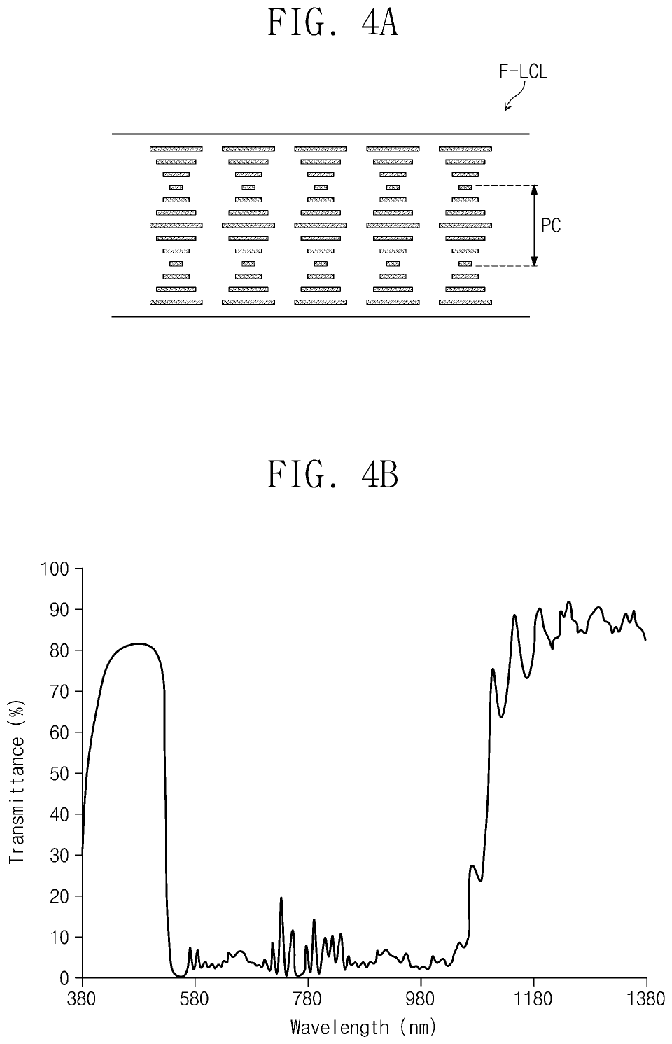

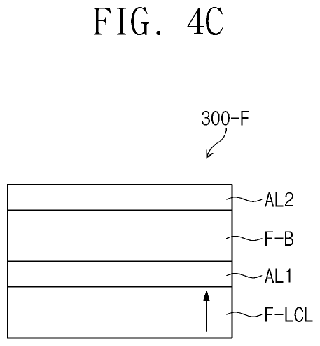

FIG. 4A is an enlarged cross-sectional view of a cholesteric liquid crystal layer F-LCL in a filter member 300-F according to the invention. FIG. 4B is a graph showing a transmission spectrum of an embodiment of a filter member 300-F according to the invention. FIG. 4C is an enlarged cross-sectional view of an embodiment of a filter member 300-F according to the invention.

As illustrated in FIGS. 4A and 4B, the filter member 300-F includes at least a cholesteric liquid crystal layer F-LCL. The cholesteric liquid crystal layer F-LCL includes a chiral dopant which induces a nematic liquid crystal having a periodic helical structure. Optical properties of the cholesteric liquid crystal layer F-LCL may be determined depending on a rotational direction of the helical structure in which the nematic liquid crystal is twisted and rotated.

The cholesteric liquid crystal layer F-LCL has a helical structure in which directors (or liquid crystal molecules) of the nematic liquid crystal are layered while being twisted along a helical axis. A distance to a second liquid crystal director rotated by 360 degrees in the helical axis direction with respect to a first liquid crystal director may be defined as a pitch PC of the cholesteric liquid crystal layer F-LCL. In the cholesteric liquid crystal layer F-LCL oriented in a planar form, an extending direction of the helical axis coincides with a normal direction of a base surface (e.g., vertical in FIG. 4A). The base surface corresponds to one surface of a base film on which the liquid crystal layer is oriented or one surface of the other members.

The cholesteric liquid crystal layer F-LCL transmits only portion of the light polarized in a direction opposite to the rotational direction of the helix and reflects remaining light. A wavelength of the reflected light may be expressed by the product of an average refractive index of the nematic liquid crystal and the pitch PC.

In a method of manufacturing a display device, when a liquid crystal composition is prepared for orienting a cholesteric liquid crystal layer F-LCL having a desired pitch, a liquid crystal molecule group is oriented to have a pitch in a predetermined range since a combination of the liquid crystal molecules in the liquid crystal molecule group constituting a pitch is randomly determined. Also, the average refractive index of the liquid crystal molecule group constituting one pitch varies from pitch to pitch since each of the liquid crystal molecules has a refractive index in a predetermined range and the combination of the liquid crystal molecules forming one pitch is randomly determined.

The cholesteric liquid crystal layer F-LCL has a refractive index in a predetermined range and is oriented to have a pitch in a predetermined range. As the refractive index range of the cholesteric liquid crystal layer F-LCL is relatively wide and the range of the pitch is relatively wide, light in a relatively wide wavelength band may be reflected. The wavelength band of the reflected light of the liquid crystal molecule group forming one pitch (Δλ1) is determined as shown in Equation 1, and the wavelength band of the reflected light of the cholesteric liquid crystal layer F-LCL including a plurality of liquid crystal molecule groups having different pitches (Δλ2) is determined as shown in Equation 2:

Wavelength band of reflected light of liquid crystal molecule group (Δλ1)=PC×Δη Equation 1

In Equation 1, PC is a pitch of a liquid crystal molecule group and Δη is a refractive index range of a liquid crystal molecule group. The refractive index range may be determined by an ordinary refractive index (nₒ) and an extraordinary refractive index (nₑ) based on birefringence properties of the liquid crystal molecules. nₒ is a refractive index in a minor direction of a liquid crystal molecule and nₑ is a refractive index in a major direction of a liquid crystal molecule. The refractive index range Δη of the liquid crystal molecule group may have a range of a minimum value of nₒ and nₑ to a maximum value of nₒ and nₑ.

In an embodiment, for example, when the first liquid crystal molecule group having a pitch of 320 nm has nₑ of 1.7-1.9 and nₒ of 1.5-1.7, Δη of the first liquid crystal molecule group may be 1.5-1.9. When the second liquid crystal molecule group having a pitch of 330 nm has nₑ of 1.7-1.8 and nₒ of 1.6-1.7, Δη of the second liquid crystal molecule group may be 1.6-1.8.

Wavelength band of reflected light of liquid crystal layer (Δλ2)=ΔPC×Δη Equation 2

In Equation 2, ΔPC is a pitch range of liquid crystal molecule groups in a cholesteric liquid crystal layer F-LCL and Δη is a refractive index range of liquid crystal molecule groups in a cholesteric liquid crystal layer F-LCL.

In an embodiment, for example, when ΔPC is 320 nm to 400 nm and Δη is 1.6-2.5, a wavelength band of reflected light of the liquid crystal layer (Δλ2) may be about 510 nm to about 1000 nm. When ΔPC is 320 nm to 400 nm and Δη is 1.5-1.9, a wavelength band of reflected light of the liquid crystal layer (Δλ2) may be about 480 nm to about 760 nm. In an embodiment, for example, ΔPC of the cholesteric liquid crystal layer F-LCL including the first liquid crystal molecule group and the second liquid crystal molecule group may be 320 nm to 330 nm and Δη may be 1.5-1.9. The reflectance in the wavelength band of reflected light of the liquid crystal layer (Δλ2) is not all the same depending on the wavelength.

As shown in FIG. 4B, among a total light incident to the cholesteric liquid crystal layer F-LCL, the cholesteric liquid crystal layer F-LCL may reflect most visible light in a wavelength range of about 530 nm to about 960 nm and may transmit about 20% or less.

The filter member 300-F may further include an alignment film to align the nematic liquid crystal more precisely in a planar form. The alignment film may be disposed or formed on one surface of the base film or one surface of another member different from the filter member 300-F. Thereafter, the liquid crystal layer may be oriented on the alignment film. The alignment film may be a polyimide film and the cholesteric liquid crystal may be oriented on the rubbed polyimide film.

The cholesteric liquid crystal layer F-LCL of the film type filter member 300-F is oriented on one surface of the base film, and the cholesteric liquid crystal layer F-LCL of the layer type filter member 300-F is oriented on one surface of another member different from the layer type filter member 300-F. In a method of manufacturing a display device, one side of the base film or one side of the other member is coated with a liquid crystal composition in a liquid state, and then, first curing is performed. The coated layer is heat-cured for about 5 minutes in an oven at about 80 degrees Celsius (° C.), and then, second curing is performed such as using an ultraviolet (“UV”) light source.

As illustrated in FIG. 4C, the filter member 300-F includes a base film F-B and a cholesteric liquid crystal layer F-LCL. Light is incident to the layers of the filter member 300-F along the direction indicated by the arrow in FIG. 4C. The filter member 300-F may further include a first adhesive layer AL1 and a second adhesive layer AL2. The base film F-B may be a synthetic resin film. The base film F-B may be, for example, a polyethylene terephthalate film. The base film F-B may be an elongation type phase retardation film. The base film F-B may be a λ/2 phase retardation film.

The first adhesive layer AL1 and/or the second adhesive layer AL2 may be a pressure sensitive adhesive layer. The first adhesive layer AL1 attaches the cholesteric liquid crystal layer F-LCL to the base film F-B and the second adhesive layer AL2 attaches the base film F-B to the another member such as the glass substrate 300-G (see FIG. 3A).

An embodiment of a method for providing the filter member 300-F will be briefly described. A cholesteric liquid crystal layer F-LCL is provided or formed on a sacrificial film. A process for applying and curing a liquid crystal material which forms the cholesteric liquid crystal layer F-LCL composition, is performed. The first adhesive layer AL1 is attached onto the cholesteric liquid crystal layer F-LCL. After attaching the first adhesive layer AL1 to the base film F-B, the sacrificial film is removed. The second adhesive layer AL2 is attached to the base film F-B.

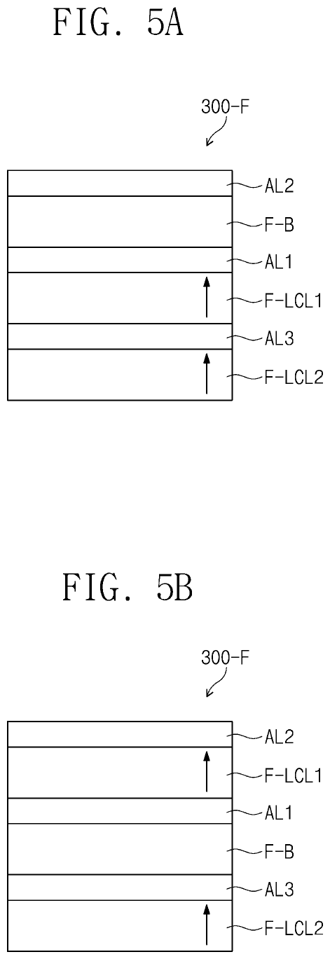

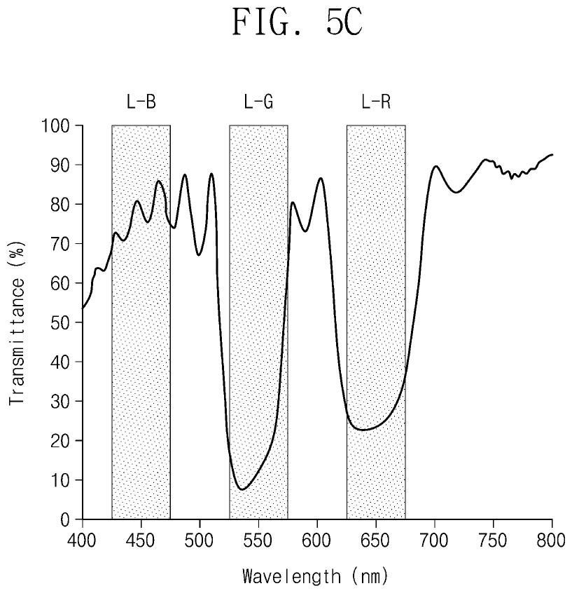

FIGS. 5A and 5B are enlarged cross-sectional views of modified embodiments of a filter element 300-F according to the invention. FIG. 5C is a graph showing a transmission spectrum of an embodiment of a filter member 300-F according to the invention.

As illustrated in FIGS. 5A and 5B, the filter member 300-F includes a base film F-B, a first cholesteric liquid crystal layer F-LCL1, and a second cholesteric liquid crystal layer F-LCL2. The filter member 300-F may further include a first adhesive layer AL1, a second adhesive layer AL2 and a third adhesive layer AL3. Light is incident to the layers of the filter member 300-F illustrated in FIGS. 5A and 5B along the direction indicated by the arrow in FIGS. 5A and 5B.

As illustrated in FIG. 5A, the first adhesive layer AL1 bonds the base film F-B and the first cholesteric liquid crystal layer F-LCL1 to each other. The second adhesive layer AL2 may attach the base film F-B to another member, for example, the glass substrate 300-G (see FIG. 3A). The third adhesive layer AL3 bonds the first cholesteric liquid crystal layer F-LCL1 and the second cholesteric liquid crystal layer F-LCL2 to each other. The first cholesteric liquid crystal layer F-LCL1 and the second cholesteric liquid crystal layer F-LCL2 may both be disposed on a same side of the base film F-B.

The first cholesteric liquid crystal layer F-LCL1 may be oriented in a right-handed helical structure and the second cholesteric liquid crystal layer F-LCL2 may be oriented in a left-handed helix structure. However, the orientation directions of the first cholesteric liquid crystal layer F-LCL1 and the second cholesteric liquid crystal layer F-LCL2 are not particularly limited.

One among the first cholesteric liquid crystal layer F-LCL1 and the second cholesteric liquid crystal layer F-LCL2 may reflect any one among the second color light L-G and the third color light L-R, and the other among the first cholesteric liquid crystal layer F-LCL1 and the second cholesteric liquid crystal layer F-LCL2 may reflect the other among the second color light L-G and the third color light L-R.

The refractive index (Δη in Equation 2) of the first cholesteric liquid crystal layer F-LCL1 reflecting green light may have an extraordinary refractive index (nₑ) of 1.7-1.9 and an ordinary refractive index (nₒ) of 1.5-1.7. The liquid crystal molecules have birefringence properties, and nₑ is a refractive index in a major direction of the liquid crystal molecules and nₒ is a refractive index in a minor direction of the liquid crystal molecules. A helical pitch (ΔPC in Equation 2) of the first cholesteric liquid crystal layer F-LCL1 may be about 320 nm to about 340 nm. The refractive index of the second cholesteric liquid crystal layer F-LCL2 reflecting red light may have an extraordinary refractive index (nₑ) of 1.7-1.9 and an ordinary refractive index (nₒ) of 1.5-1.7, and a helical pitch of the second cholesteric liquid crystal layer F-LCL2 may be about 370 nm to about 390 nm.

The filter member 300-F illustrated in FIG. 5B has a different stacking order compared with the filter member 300-F illustrated in FIG. 5A. The filter member 300-F illustrated in FIG. 5B may also reflect the second color light L-G and the third color light L-R. The first cholesteric liquid crystal layer F-LCL1 and the second cholesteric liquid crystal layer F-LCL2 in FIG. 5B may be disposed at different sides of the base film F-B.

The cholesteric liquid crystal layer F-LCL in FIG. 4C or the second cholesteric liquid crystal layer F-LCL2 in FIGS. 5A and 5B are a lowermost layer within the filter member 300-F, and may be directly disposed relative to another member within the optical member 300.

As shown in FIG. 5C, the filter member 300-F illustrated in FIGS. 5A and 5B may transmit about 30% or less if the second color light L-G in a wavelength range of about 525 nm to about 575 nm and the third color light L-R in a wavelength range of about 625 nm to about 675 nm, among a total of such color light incident to the filter member 300-F.

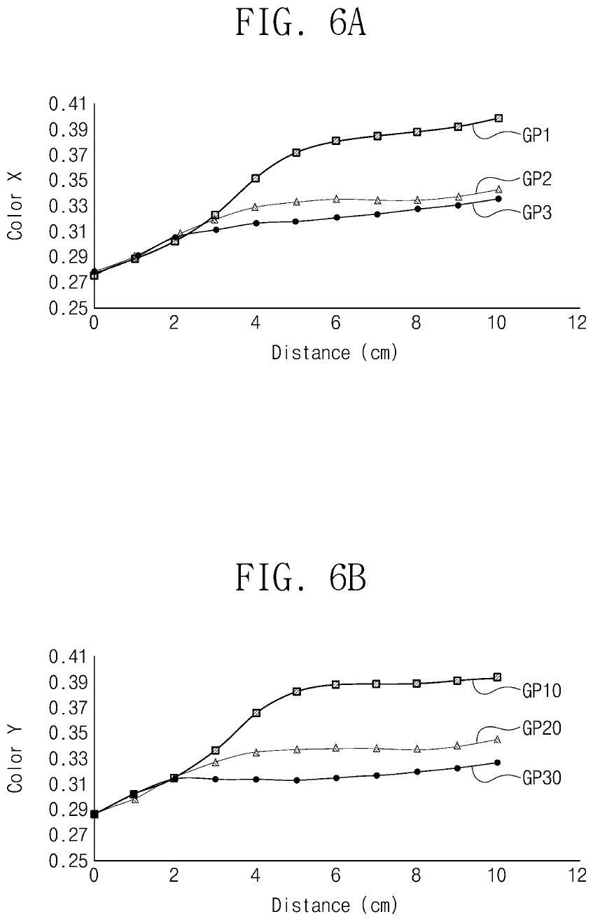

FIGS. 6A and 6B are graphs showing color differences according to distances in centimeters (cm) from a reference point of a light emitting element 200-L. The graphs in FIGS. 6A and 6B show a change amount of an x-axis value (color X, hereinafter referred to as an x-axis value) according to the CIE 1931 color coordinate system and a y-axis value (color Y, hereinafter referred to as a y-axis value) according to the CIE 1931 color coordinate system. An X-axis in FIGS. 6A and 6B represents a distance from a reference point of a light emitting element 200-L. More particularly, the reference point is a point of the first light emitting element 200-L1 illustrated in FIG. 3B, from which light is projected outwardly from the first light emitting element 200-L1 and toward the display panel 100 along the third direction axis DR3. The distance from the reference point was measured along the first direction axis DR1. A Y-axis in FIG. 6A represents the x-axis value (color X) and a Y-axis in FIG. 6B represents the y-axis value (color Y).

First graphs GP1 and GP10 represent a change amount of an x-axis value (color X) and a y-axis value (color Y) depending on a distance of the display device according to Comparative Example. The display device according to Comparative Example does not include a filter member 300-F with reference to the display device illustrated in FIG. 3A.

Second graphs GP2 and GP20 represent a change amount of an x-axis value (color X) and a y-axis value (color Y) depending on a distance from a reference point of a light emitting element 200-L of a display device according to the invention. The display device represented by the second graphs GP2 and GP20 includes one filter layer which reflects light in a wavelength range of about 500 nm to about 960 nm as the filter member 300-F with reference to the display device illustrated in FIG. 3A.

Third graphs GP3 and GP30 represent a change amount of an x-axis value (color X) and a y-axis value (color Y) depending on a distance from a reference point of a light emitting element 200-L of a display device according to the invention. The display device represented by the third graphs GP3 and GP30 includes a first filter layer reflecting light in a wavelength range of about 525 nm to about 575 nm and a second filter layer reflecting light in a wavelength range of about 625 nm to about 675 nm as the filter member 300-F with reference to the display device illustrated in FIG. 3A.

Taking FIGS. 3B, 6A and 6B together, since one or more filter layer reduces the amount of light which leaks into the second display area OFF-A1 (see FIG. 3B) and the third display area OFF-A2 (see FIG. 3B), the change amount of the x-axis value (color X) and the y-axis value (color Y) measured at a predetermined distance or more far from the reference point in the display devices represented by the second graphs GP2 and GP20 and the third graphs GP3 and GP30 is relatively small as compared with the display device represented by the first graphs GP1 and GP10.

Where the filter layer of the display device represented by the second graphs GP2 and GP20 reflects light in a relatively wide wavelength range of about 500 nm to about 960 nm, the first filter layer and the second filter layer of the display device represented by the third graphs GP3 and GP30 have relatively narrow reflection wavelength ranges but have high reflectance. Accordingly, the x-axis value (color X) and y-axis value (color Y) of the third graphs GP3 and GP30 measured at a predetermined distance far from the reference point are smaller than the measured x-axis value (color X) and y-axis value (color Y) of the second graphs GP2 and GP20.

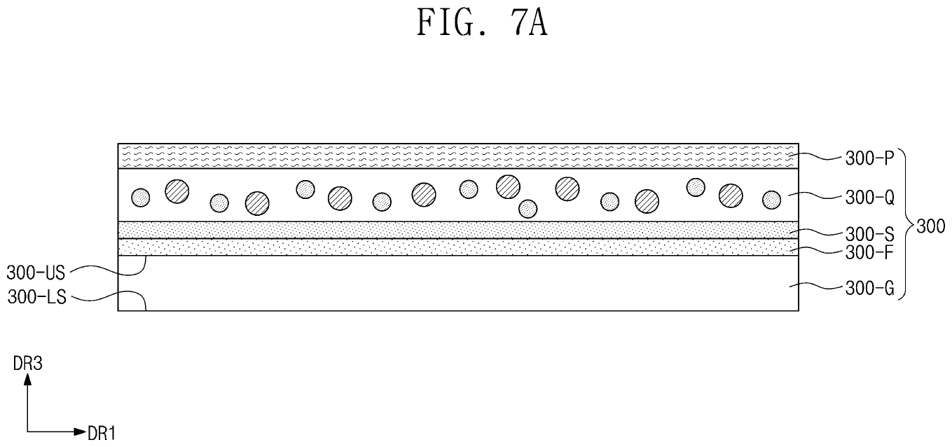

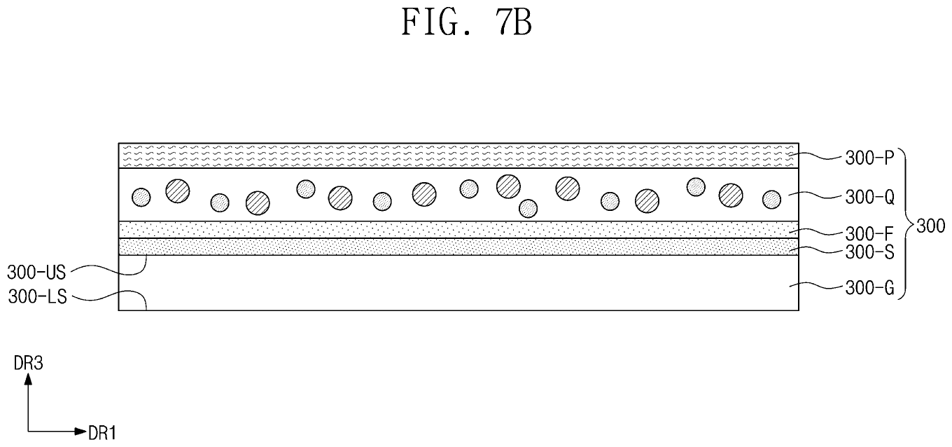

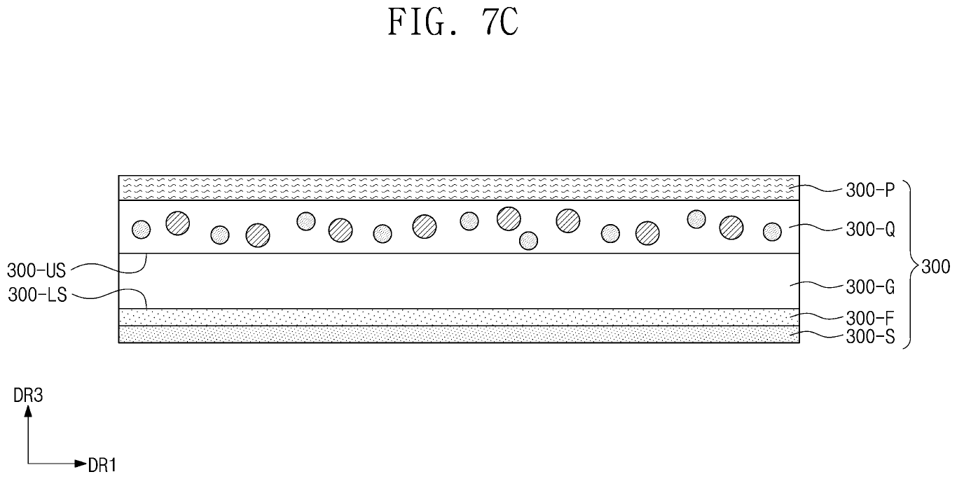

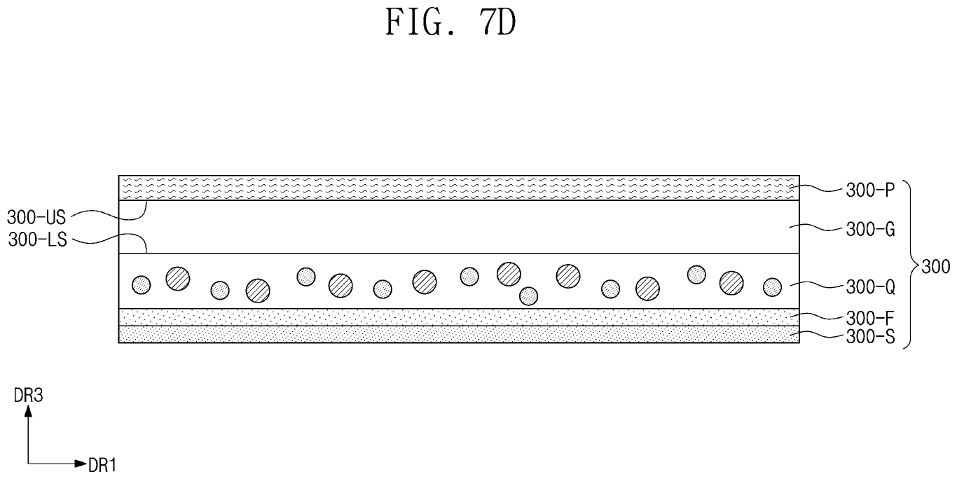

FIGS. 7A to 7D are cross-sectional views illustrating modified embodiments of a portion of a display device according to the invention. Hereinafter, a detailed description for the same configuration as the configuration described with reference to FIGS. 1 to 6B will be omitted. As applicable to an entirety of the present disclosure, elements being “directly disposed” relative to each other may form an interface therebetween without being limited thereto. In FIGS. 7A to 7D, the quantum dot member 300-Q follows the filter member 300-F along a light emitting direction (e.g., third direction axis DR3), such that the filter member 300-F may reflect leaked light back toward the quantum dot member 300-Q as shown in FIG. 3B discussed above.

As illustrated in FIG. 7A, the filter member 300-F is directly disposed on the upper surface 300-US of the glass substrate 300-G. The filter member 300-F may form an interface with the upper surface 300-US of the glass substrate 300-G. FIG. 7A illustrates an exemplary layer type filter member 300-F disposed directly on the upper surface 300-LS of the glass substrate 300-G. The layer type filter member 300-F may include therein one filter layer which reflects light in a wavelength range of about 500 nm to about 960 nm, or both of a first filter layer which reflects light in a wavelength range of about 525 nm to about 575 nm and a second filter layer which reflects light in a wavelength range of about 625 nm to about 675 nm.

As illustrated in FIG. 7B, the stacking order of the filter member 300-F and the scattering member 300-S may be changed. The filter member 300-F may be a layer type or a film type. When a layer type filter member 300-F is applied, the filter layer of the filter member 300-F may be directly disposed on the upper surface of the scattering member 300-S or on the lower surface of the quantum dot member 300-Q. The filter member 300-F may form an interface with the upper surface of the scattering member 300-S or the lower surface of the quantum dot member 300-Q.

As illustrated in FIG. 7C, the filter member 300-F may be disposed on the lower surface 300-LS of the glass substrate 300-G. The scattering member 300-S may be disposed on the lower surface of the filter member 300-F and the stacking order of the filter member 300-F and the scattering member 300-S may be changed.

As illustrated in FIG. 7D, the quantum dot member 300-Q may be disposed on the lower surface 300-LS of the glass substrate 300-G. The filter member 300-F may be disposed on the lower surface of the quantum dot member 300-Q.

In one or more embodiment, the base substrate of the optical member supports the functional layers of the optical member. Even if optical distances along a light emitting direction, between the light emitting elements and the base substrate of the optical member are relatively small, defects minimally occur because less thermal deformation of the glass substrate occurs.

The display device may provide a relatively high luminous image using the quantum dot member together with the optical member according to one or more embodiment.

The filter member may reduce or effectively prevent the green light and the red light emitted from the quantum dot member at a turned-on area of the light emitting unit from leaking to the turned-off area of the light emitting unit. The yellow hollow (or luminescence ring) phenomenon occurring around the turned-on area of the light emitting unit is reduced by effectively preventing leakage light from being incident on the turned-off area of the light emitting unit, due to the filter member.

Although embodiments of the invention have been described, it is understood that the invention should not be limited to these embodiments but various changes and modifications can be made by one ordinary skilled in the art within the spirit and scope of the invention as hereinafter claimed.

What is claimed is:

1. A display device comprising:
a light emitting unit which generates and emits a first color light;
an optical member in which the first color light which is incident from the light emitting unit is color-converted and from which color-converted light is emitted; and
a display panel to which the color-converted light which is emitted from the optical member is provided,
wherein the optical member comprises:
a quantum dot member which transmits a portion of the first color light and color-converts a portion of the first color light into a second color light and a third color light; and
a filter member between the light emitting unit and the quantum dot member, the filter member comprising a cholesteric liquid crystal layer which reflects at least one of the second color light and the third color light which is incident to the filter member from the quantum dot member.

2. The display device of claim 1, wherein the first color light has a maximum peak wavelength of about 440 nanometers to about 460 nanometers.

3. The display device of claim 1, wherein the optical member further comprises a base substrate which overlaps the light emitting unit, the base substrate comprising a glass substrate.

4. The display device of claim 1, wherein
the optical member further comprises a base substrate which overlaps the light emitting unit, the base substrate including a lower surface facing the light emitting unit and an upper surface facing the display panel, and
the cholesteric liquid crystal layer of the filter member forms an interface with the lower surface or the upper surface of the base substrate.

5. The display device of claim 1, the cholesteric liquid crystal layer of the filter member forms an interface with the quantum dot member.

6. The display device of claim 1, wherein the filter member between the light emitting unit and the quantum dot member further comprises:
a base film; and
an adhesive layer which bonds the base film to the cholesteric liquid crystal layer.

7. The display device of claim 1, wherein the filter member between the light emitting unit and the quantum dot member comprises:
a first cholesteric liquid crystal layer which reflects the second color light, and
a second cholesteric liquid crystal layer which reflects the third color light.

8. The display device of claim 7, wherein the filter member between the light emitting unit and the quantum dot member further comprises a base film between the first cholesteric liquid crystal layer and the second cholesteric liquid crystal layer.

9. The display device of claim 8, wherein the base film between the first cholesteric liquid crystal layer and the second cholesteric liquid crystal layer is a λ/2 phase retardation film.

10. The display device of claim 7, wherein the filter member between the light emitting unit and the quantum dot member further comprises:
a base film;
a first adhesive layer which bonds the base film to the first cholesteric liquid crystal layer; and
a second adhesive layer which bonds the first cholesteric liquid crystal layer to the second cholesteric liquid crystal layer.

11. The display device of claim 7, wherein
the second color light has a maximum peak wavelength of about 515 nanometers to about 545 nanometers, and liquid crystal molecules, within the first cholesteric liquid crystal layer of a same filter member comprising the second cholesteric liquid crystal layer, are arranged in a helix,
a refractive index in a major direction of a liquid crystal molecule of the liquid crystal molecules is about 1.7 to about 1.9,
a refractive index in a minor direction of a liquid crystal molecule of the liquid crystal molecules is about 1.5 to about 1.7, and
a helical pitch of the liquid crystal molecules is about 320 nanometers to about 340 nanometers.

12. The display device of claim 7, wherein
the third color light has a maximum peak wavelength of about 610 nanometers to about 645 nanometers, and
liquid crystal molecules, within the second cholesteric liquid crystal layer of a same filter member comprising the first cholesteric liquid crystal layer, are arranged in a helix,
a refractive index in a major direction of a liquid crystal molecule of the liquid crystal molecules is about 1.7 to about 1.9,
a refractive index in a minor direction of a liquid crystal molecule of the liquid crystal molecules is about 1.5 to about 1.7, and
a helical pitch of the liquid crystal molecules is about 370 nanometers to about 390 nanometers.

13. The display device of claim 1, wherein the light emitting unit comprises a circuit substrate and a plurality of light emitting elements which are mounted on the circuit substrate.

14. The display device of claim 13, wherein the plurality of light emitting elements within the light emitting unit are independently controllable to be turned on and turned off independent of each other.

15. The display device of claim 1, wherein the optical member further comprises a scattering layer which scatters light incident thereto, the scattering layer disposed between the quantum dot member and the light emitting unit.

16. The display device of claim 15, wherein
the scattering layer comprises a base resin layer and scattering particles which are in the base resin layer, and
the scattering particles comprise at least one among TiO₂, SiO₂, ZnO, Al₂O₃, BaSO₄, CaCO₃, and ZrO₂.

17. A display device comprising:
a light emitting unit which generates and emits a blue light;
an optical member in which the blue light which is incident from the light emitting unit is color-converted and from which color-converted light is emitted; and
a display panel to which the color-converted light which is emitted from the optical member is provided,
wherein the optical member comprises:
a quantum dot layer which transmits a portion of the blue light and color-converts a portion of the blue light into green light and red light; and
a filter member between the light emitting unit and the quantum dot layer,
wherein the filter member comprises
a cholesteric liquid crystal layer having a helical structure in which liquid crystal molecules are twisted along a helical axis and an extending direction of the helical axis is normal with respect to an upper surface of the optical member.

18. The display device of claim 17, wherein
the optical member further comprises a glass substrate which overlaps the light emitting unit, the glass substrate including a lower surface facing the light emitting unit and an upper surface facing the display panel, and
the cholesteric liquid crystal layer of the filter member forms an interface with the lower surface or the upper surface of the glass substrate.

19. The display device of claim 17, wherein the filter member between the light emitting unit and the quantum dot layer comprises:
a first cholesteric liquid crystal layer which reflects the green light, and
a second cholesteric liquid crystal layer which reflects the red light.

20. The display device of claim 19, wherein the filter member between the light emitting unit and the quantum dot layer further comprises a λ/2 phase retardation film between the first cholesteric liquid crystal layer and the second cholesteric liquid crystal layer.
